(19) United States
(12) Patent Application Publication
(10) Pub. No.: US 2015/0232111 A1
(43) Pub. Date: Aug. 20, 2015

(54) System and Method for Transporting Boxes and Box-Like Containers

(71) Applicants: Marshall Stauber, Hollywood, FL (US); Justin Stauber, Hollywood, FL (US)

(72) Inventors: Marshall Stauber, Hollywood, FL (US); Justin Stauber, Hollywood, FL (US)

(21) Appl. No.: 14/183,232

(22) Filed: Feb. 18, 2014

(51) Int. Cl. B62B 1/12; B65D 5/44; B62B 1/16; B60B 35/00; B60B 37/10

(52) U.S. Cl. CPC B62B 1/12; B60B 35/004; B60B 37/10; B62B 1/16; B65D 5/44

(57) ABSTRACT

The present invention is a system and method for transporting a container including a which is assembled into a box; at least one axle affixed by a user and associated with said box; at least two wheels dependent on said axle; a strap constructed and arranged for securing about the perimeter of said box and configured for movement, yet allowing stackability, and side by side placement of box for mass transportation.

### BACKGROUND OF THE INVENTION

### Field of the Invention

There are many articles existing that assist in transport of packages. With each of the significant advancements, there remains a significant deficiency. There is no effective system for wheeling a box or box-like container that does not include utilizing a cart or dolly-type system. There is a need for a system that would incorporate wheels into boxes without impeding stacking of or placing side by side and other containers to provide for ease of transport.

### SUMMARY OF THE INVENTION

In one embodiment, the present invention is a system for transporting a container, said system comprising: a box; at least one axle affixed by a user and associated with said box; at least two wheels dependent on said axle; a strap constructed and arranged for securing about the perimeter of said box and configured for movement of the system with limited protrusion from side or bottom.

In one configuration, the axle extends through the interior of said box.

The box, in one embodiment, is provided as a flat, foldable material such as cardboard, corrugated paper, plastics, polymers, combinations thereof and the like, whereby the material has a plurality of score lines and cut lines configured for assembly into the box.

The box, in one embodiment, is provided as a pattern with a plurality of score lines and cut lines configured for assembly into said box, including score lines configured to form opposing openings through which an axle will pass.

In one embodiment, the axle is permanently attached by a user to the interior of the box.

In another embodiment, the axle is removably attached by a user to the interior of the box.

The present invention further contemplates a method of transporting a box, said method comprising the steps of: providing a system of the present invention; attaching at least one axle to said box; and affixing at least 2 wheels to said axle.

Additionally, the method may include positioning a strap perpendicular to said axle around the perimeter of the box.

The method, in one embodiment, includes forming at least two wheel well openings on opposing sides in which the axle is positioned within an interior of the box and is accessible through said wheel well openings.

In one embodiment, the method includes attaching the axle to the interior of the box and opposing axle ends are accessible from outside the box.

In one embodiment, the method includes providing an unassembled box with fold lines for folding and score lines for removing portions of the unassembled box and forming into a box having at least two wheel well openings thereon.

BRIEF DESCRIPTION OF THE SEVERAL VIEWS OF THE DRAWING

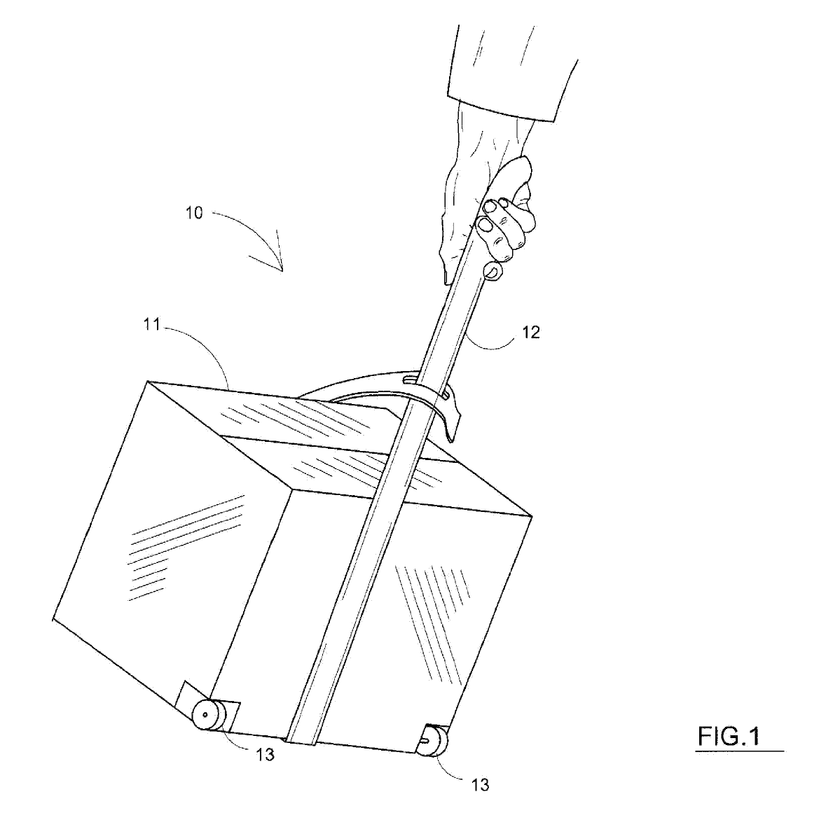

FIG. 1 is a perspective view of the invention in use.

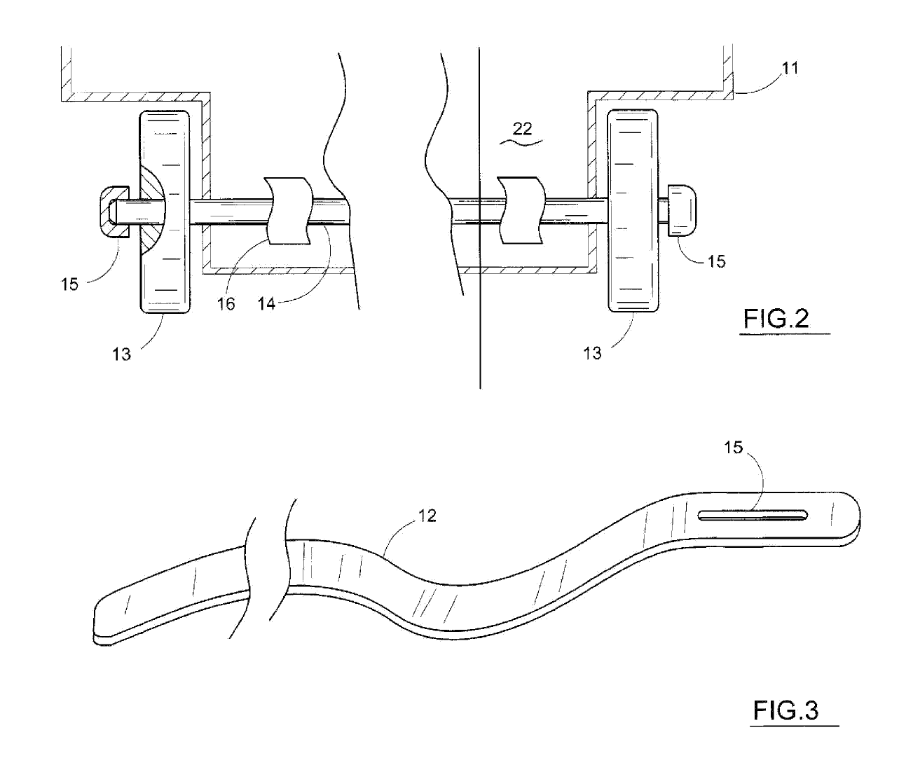

FIG. 2 is a partial cross-section view of the axle and wheel assembly of the present invention.

FIG. 3 is a perspective view of the attaching and carrying strap according to one embodiment of the present invention.

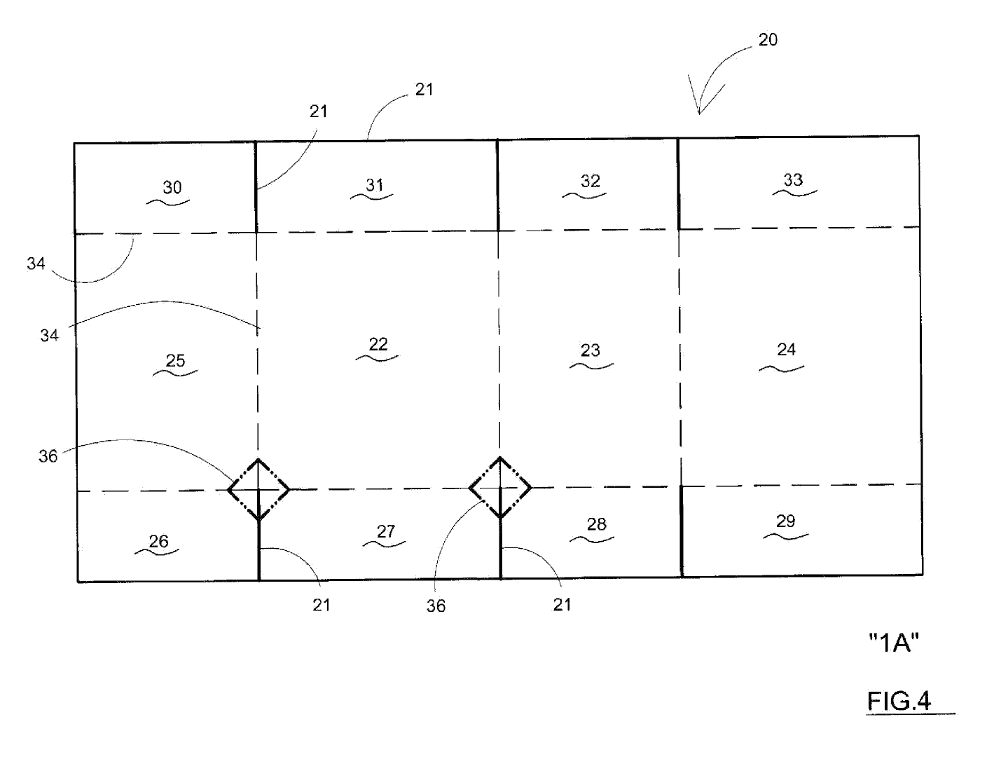

FIG. 4 is a plan view of a pattern demonstrative of one embodiment of the present invention configured for pushing in corners without cutting.

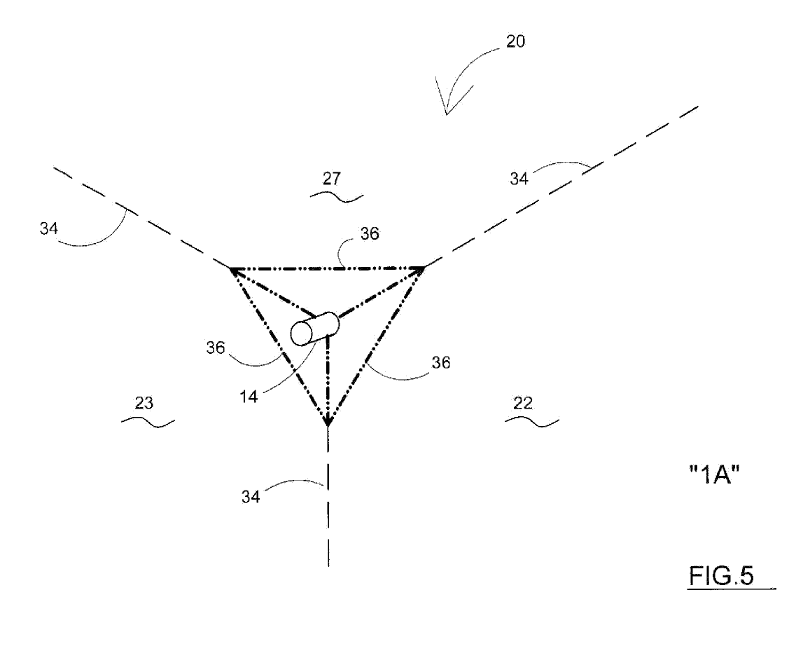

FIG. 5 is a partial pattern demonstrating triangular pattern perforations used in an embodiment of the present invention.

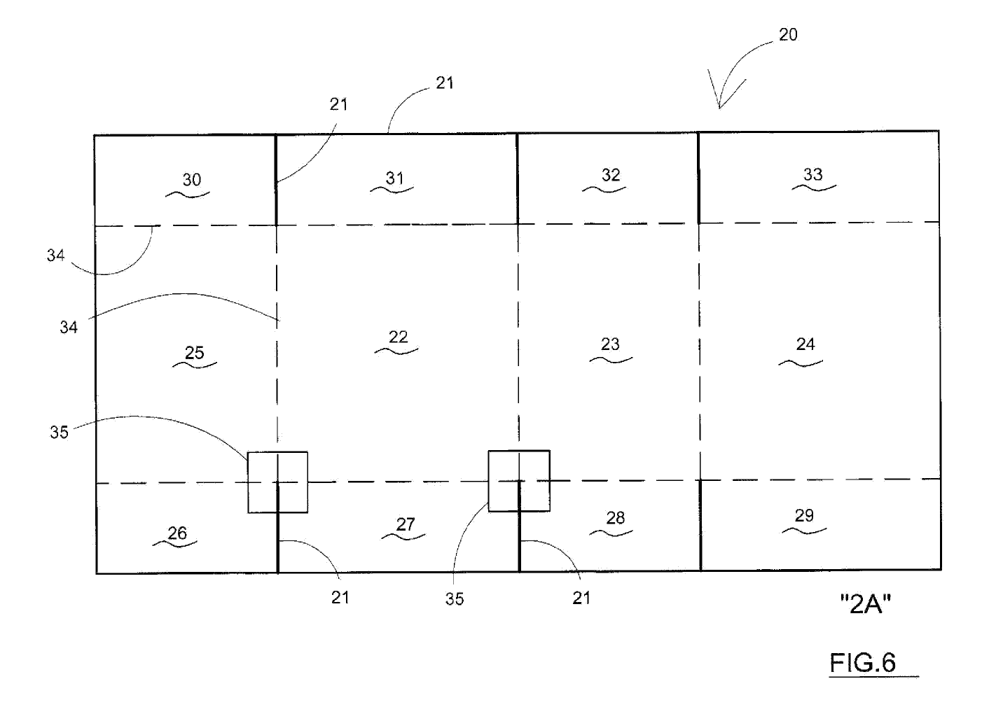

FIG. 6 is a plan view of a pattern according to the present invention.

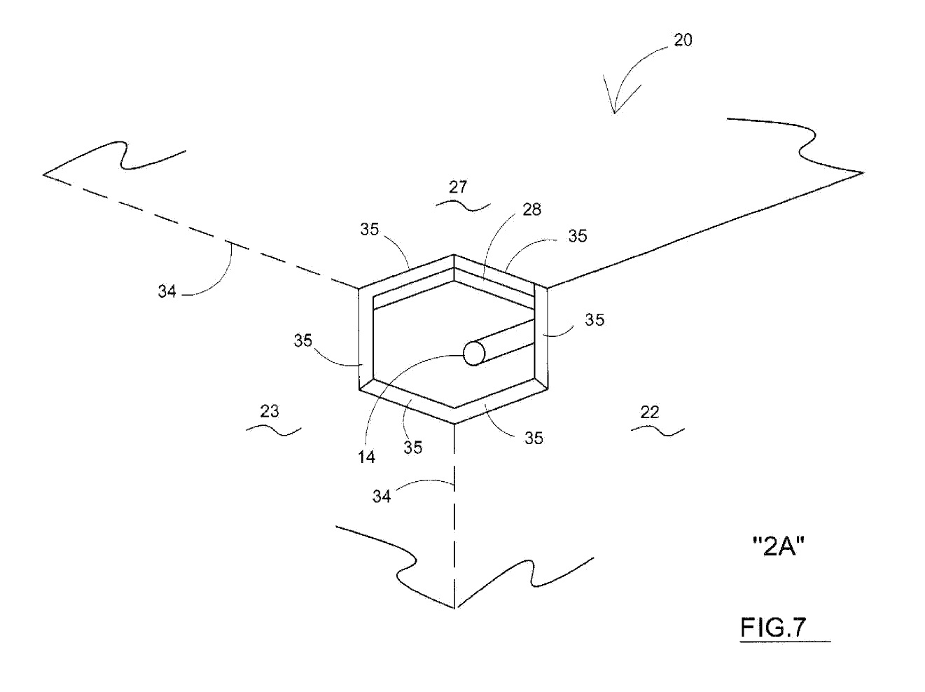

FIG. 7 is a partial perspective view of the present invention demonstrative of an axle extending outward from a container.

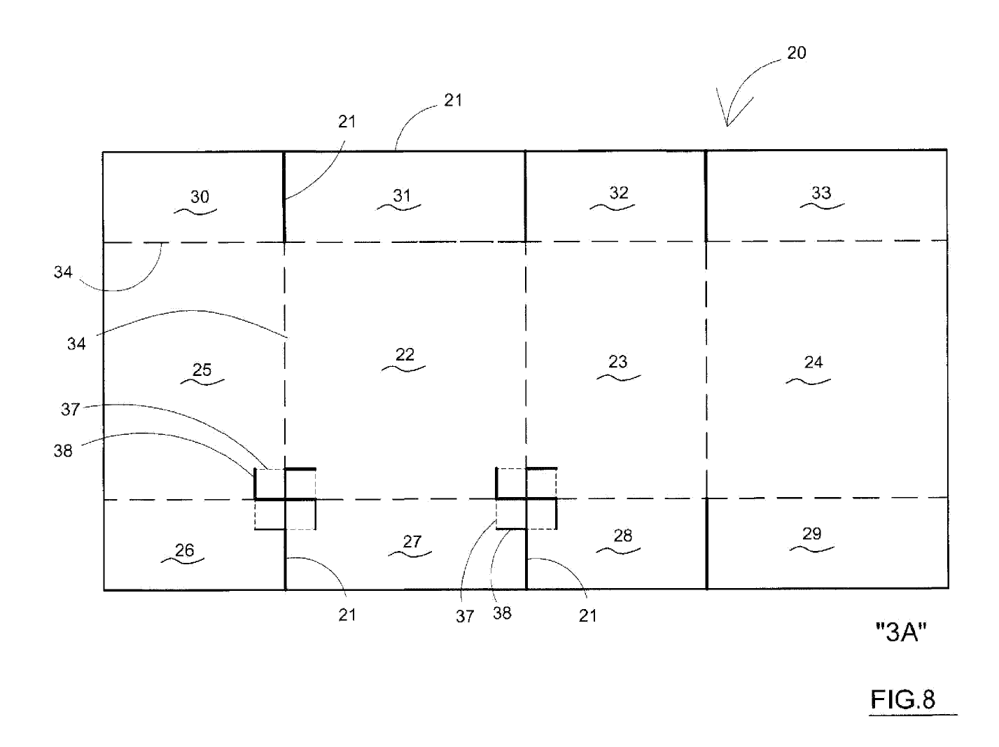

FIG. 8 is a plan view of a pattern of one embodiment according to the present invention.

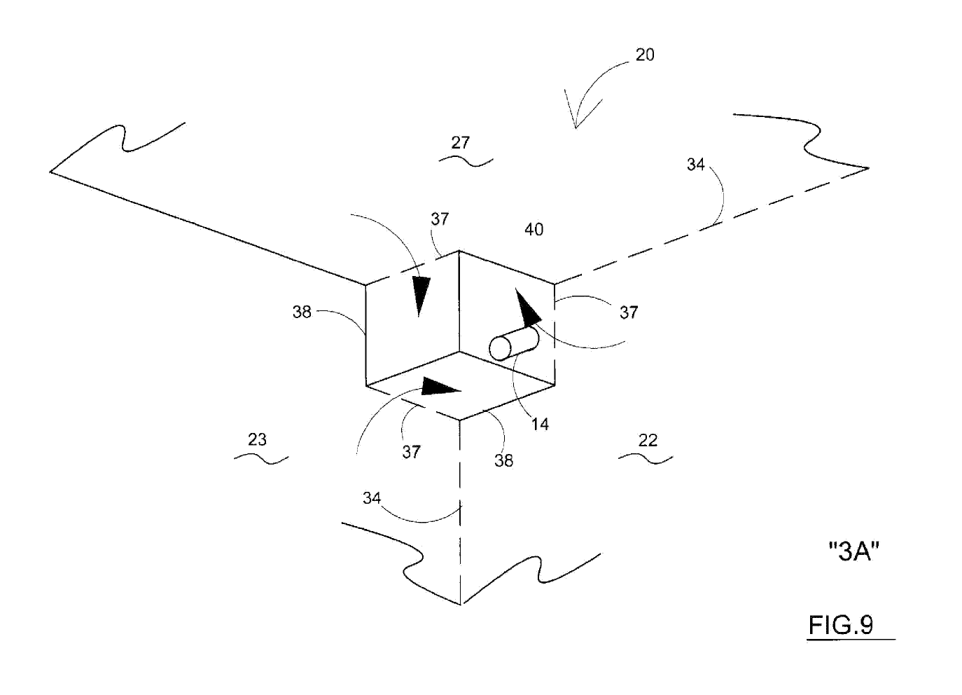

FIG. 9 is a partial perspective view of a configuration demonstrating folds whereby an axle of the present invention is exposed.

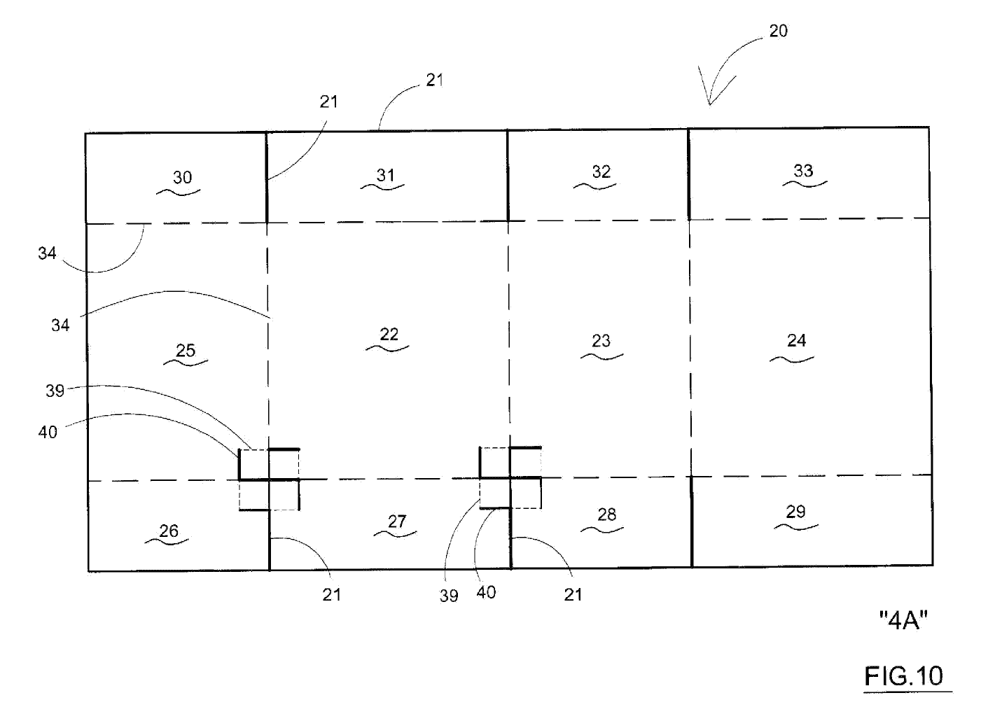

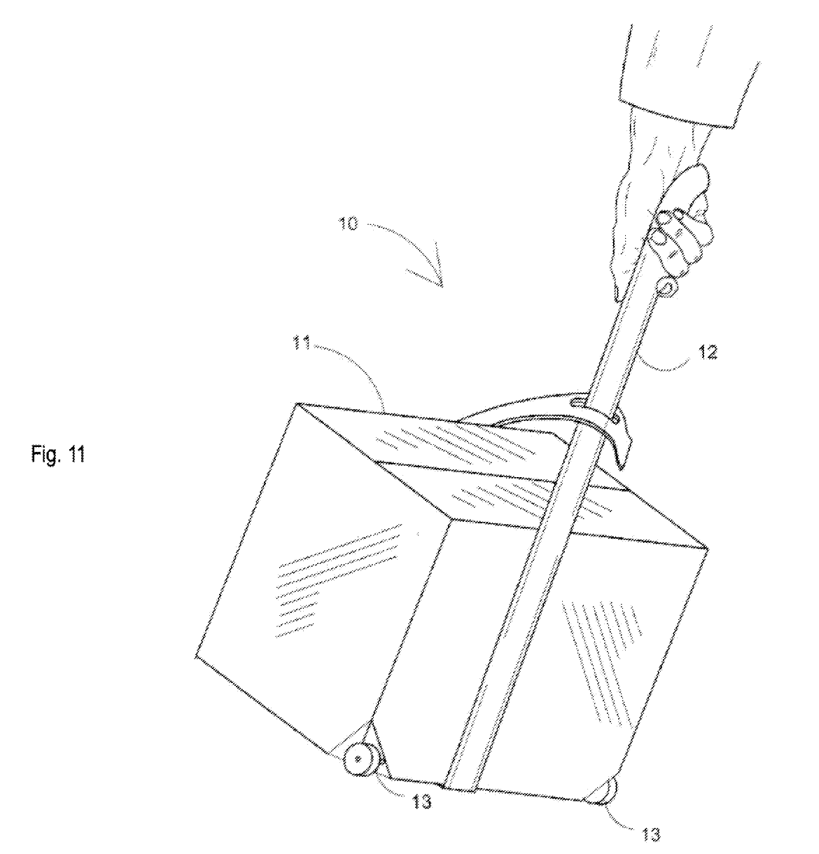

FIG. 10 is a plan view of one configuration of a pattern according to the present invention.

FIG. 11 is a perspective view of one embodiment of the present invention in use.

### DETAILED DESCRIPTION OF THE PREFERRED EMBODIMENT

The present invention includes a system and method for transporting boxes and other containers. System 10 includes a box 11 and carry strap 12. Box 11 has affixed thereto at least one axle 14. Wheels 13 are dependent upon axle 14 and secured into position with securing cap 15. In one embodiment, axle 14 is secured to box 11 with securing fasteners 16. Securing fasteners includes any suitable fastener, but is not limited to, adhesive tape, hook and loop fasteners, and the like. It is contemplated that a user will utilize fastener 16 to affix axle 14 into position. Strap 12 is configured in one embodiment with an incorporated slot 15 on a first end. In use, a user will pass the opposite end of strap 12 through incorporated slot 15, as demonstrated in FIGS. 1 and 11.

In one embodiment, as demonstrated in FIG. 4, a flexible material, such as cardboard or other suitable box-forming material is provided with a pre-stamped pattern thereon. In one embodiment, as demonstrated in assembly 20, a plurality of panels includes rear panel portion 22, left side panel portion 23, front panel portion 24, and right side panel portion 25. A user will cut along each of cut lines 21 such that top right panel portion 30, top rear panel portion 31, top left panel portion 32 and top front panel portion 33 correspond to bottom right panel portion 26, bottom real panel portion 27, bottom left panel portion 28, and bottom front panel portion 29. A user will then bend the Assembly 20 along score lines 34, forming Assembly 20 into a generally rectangular solid configuration. Assembly 20 further includes at least two wheel well scored portions 36, the score lines 36 in this embodiment allows corners to be pushed in, similar to an origami technique when box is assembled. As generally understood, as used herein, the term wheel well refers to the opening in the box. The wheel either nests within the well or can protrude outward from the box. When the wheel is positioned beyond the periphery of the box, the wheel well is the opening in which the axle extends to the outer region of the box.

In one embodiment, as demonstrated in FIG. 5, scored wheel well portions 36 are in a triangular configuration, permitting axle 14 to extend outward from the assembled box through any portion of well. The scored wheel well portion is configurable as desired. For example, FIG. 6 is demonstrative of a square configuration of wheel well scored portion 35. In this configuration, as demonstrated in FIG. 7, the square portion provides an opening through which axle 14 is accessed from the outside of the box.

As generally understood, the portion can take on many configurations, such as that demonstrated in FIG. 8, whereby a combination of wheel well score lines 37 and wheel well cut lines 38 are utilized to form the opening through which axle 14 is accessed. Further demonstrative of the present invention is demonstrated in FIG. 10, whereby another embodiment incorporating both scored lines 39 and cut lines for wheel well 40 are utilized in order to produce the desired cavity through which axle 14 is accessed.

It is contemplated that the present invention have an embodiment whereby a box is provided, as described herein, whereby the assembled box has incorporated therewith the axle and wheel assemblies in order to provide ease of transport. Additionally, it is contemplated that the present invention includes a system whereby an axle and wheel assembly is provided and utilized with any existing box such that a user can utilize the system and method of the present invention without the need of purchasing any particular specialty box.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for transporting a container, said system comprising: a box, said box provided with at least one of a pre-cut wheel well, score line for folding, score line for cutting a wheel well, or combinations thereof; at least one axle affixed by a user and associated with said box; at least two wheels dependent on said axle.

2. The system of claim 1 whereby said axle extends through the interior of said box.

3. The system of claim 1 whereby said box is provided as a flat material with at least one of a plurality of score lines or a cut lines configured for assembly into the box having a pair of opposing wheel wells.

4. The system of claim 1 whereby said box is provided as a pattern with a plurality of score lines and cut lines configured for assembly into said box, including score lines configured to form opposing openings through which an axle positioned on an interior of the box, will be accessible from outside the box.

5. The system of claim 1 whereby said axle is permanently attached by a user to the interior of the box.

6. The system of claim 1 whereby said axle is removably attached by a user to the interior of the box.

7. A method of transporting a box, said method comprising the steps of:
providing a system of claim 1;
attaching at least one axle to said box; and
affixing at least 2 wheels to said axle.

8. The method of claim 7 further comprising forming at least two wheel well openings on opposing sides in which the axle is positioned within an interior of the box and is accessible through said wheel well openings.

9. The method of claim 7 further comprising attaching the axle to the interior of the box and opposing axle ends are accessible from outside the box.

10. The method of claim 7 further comprising providing an unassembled box with fold lines for folding or score lines for positioning or removing portions of the unassembled box and forming into a box having at least two wheel well openings thereon.

11. The method of claim 7 further comprising positioning a strap perpendicular to said axle around the perimeter of the box.
